(19) United States
(12) Patent Application Publication
(10) Pub. No.: US 2017/0235442 A1
(43) Pub. Date: Aug. 17, 2017

(54) METHOD AND ELECTRONIC DEVICE FOR COMPOSING SCREEN

(71) Applicant: Samsung Electronics Co., Ltd., Gyeonggi-do (KR)

(72) Inventors: Gong Hwan Jung, Hwaseong-si (KR); Jung Eun Lee, Suwon-si (KR)

(21) Appl. No.: 15/435,207

(22) Filed: Feb. 16, 2017

(30) Foreign Application Priority Data
Feb. 16, 2016 (KR) 10-2016-0017666

(51) Int. Cl. G06F 3/0482; G06F 3/0488; G06F 3/0484; G06F 3/0481

(52) U.S. Cl. CPC G06F 3/0482; G06F 3/04817; G06F 3/0488; G06F 3/04845

(57) ABSTRACT

An electronic device includes a display, a memory, and a processor. The processor renders a plurality of views, which are based on execution of at least one application, to store the plurality of views in the memory. The processor also generates a first image frame based on a first group of views that includes at least one view selected from the plurality of views. The processor also outputs the first image frame in the display.

### CROSS-REFERENCE TO RELATED APPLICATION AND CLAIM OF PRIORITY

The present application is related to and claims the benefit under 35 U.S.C. §119(a) of a Korean patent application filed on Feb. 16, 2016 in the Korean Intellectual Property Office and assigned Serial number 10-2016-0017666, the entire disclosure of which is hereby incorporated by reference.

### TECHNICAL FIELD

This disclosure relates to a method for composing a view, which composes a screen of a display, and an electronic device performing the same.

### BACKGROUND

With the developments of wireless technologies, an electronic device is handy to carry and is able to freely connect to wired/wireless networks. For example, portable electronic devices such as a smartphone, a tablet personal computer (PC), and the like are able to support various functions, such as a game, Internet connection, and a playback of multimedia content in addition to a call function and a message sending/receiving function.

For example, to provide the various functions, the electronic device may perform application programs corresponding to the functions.

An image frame provided to a display may be defined in advance in an application program executed by the electronic device. For example, rendering information and a layout of at least one view that composes the image frame may be designed in advance by a developer of the application program.

Even though an image, a video, a text, or the like (e.g., an advertisement) that a user does not desire is included in a part of an execution screen, it is troublesome for the user to remove the image, the video, the text, or the like at his/her desire.

For example, even though an electronic device shares an execution screen with an external electronic device through display mirroring, the same execution screen, in which all views are included, is only output in a display of the electronic device and the external electronic device, and a screen including only “some views” other than one or more views is not output.

Accordingly, it is troublesome for the user to send “some views”, which are included in the execution screen, to the external electronic device based on his/her own preference. Alternatively, it is troublesome for the user to record or capture “some views” based on his/her own preference. Furthermore, when the user desires to output a screen, which includes only “some views”, in the external electronic device, a computing resource may be considerably consumed because an image frame for the screen including only “some views” needs to be newly rendered.

### SUMMARY

Aspects of this disclosure are to address at least the above-mentioned problems and/or disadvantages and to provide at least the advantages described below. Accordingly, an aspect of this disclosure is to provide a screen composing method that reconfigures views, which compose an image frame, in a framework layer of an electronic device at his/her own preference, and an electronic device performing the same.

To address the above-discussed deficiencies, it is a primary object to provide an electronic device includes a display, a memory, and a processor. The processor is configured to render a plurality of views that are based on execution of at least one application, to store the plurality of views in the memory, to generate a first image frame based on a first group of views that includes at least one view selected from the plurality of views, and to output the first image frame in the display.

In accordance with an aspect of this disclosure, an electronic device includes a memory configured to store information about at least one view and a processor. The processor is configured to output a first screen, which includes a first view and a second view associated with execution of at least one application, through a display operatively connected with the processor and to generate a second screen to be sent to an external electronic device based at least on selection of the first view or the second view. The second screen includes the selected view.

In accordance with an aspect of this disclosure, a method of an electronic device for composing a screen includes rendering a plurality of views that are based on execution of at least one application, storing the plurality of views in a memory of the electronic device, generating a first image frame based on a first group of views that includes at least one view selected from the plurality of views, and outputting the first image frame in a display of the electronic device.

In accordance with an aspect of this disclosure, in a computer recording medium storing instructions that are executed by at least one processor and is readable by a computer, the instruction causes the computer to render a plurality of views that are based on execution of at least one application, to generate a first image frame based on a first group of views that includes at least one view selected from the plurality of views, and to output the first image frame in a display of the electronic device.

Other aspects, advantages, and salient features of the disclosure will become apparent to those skilled in the art from the following detailed description, which, taken in conjunction with the annexed drawings, discloses various embodiments of this disclosure.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a drawing for describing a view, according to various embodiments;

FIG. 2 illustrates a block diagram of an electronic device, according to various embodiments of this disclosure;

FIG. 3 illustrates a hierarchical block diagram of an electronic device in terms of software, according to various embodiments;

FIG. 4 is a drawing for describing a method for composing a screen, according to an embodiment;

FIG. 5 is a drawing for describing an operation of an electronic device, according to an embodiment;

FIG. 6A illustrates a method for composing a screen, according to an embodiment;

FIG. 6B illustrates a method for composing a screen, according to another embodiment;

FIG. 7 illustrates a method for composing a screen, according to another embodiment;

FIG. 8 illustrates screens of an electronic device for describing a screen composing method, according to an embodiment;

FIG. 9 illustrates a method for describing sharing a screen with a plurality of electronic devices by using a method for composing a screen, according to an embodiment;

FIG. 10 is a drawing for describing sharing a screen with a plurality of electronic devices by using a method for composing a screen, according to an embodiment;

FIG. 11 illustrates a block diagram of an electronic device, according to various embodiments; and

FIG. 12 illustrates a block diagram of a program module, according to various embodiments.

Throughout the drawings, it should be noted that like reference numbers are used to depict the same or similar elements, features, and structures.

### DETAILED DESCRIPTION

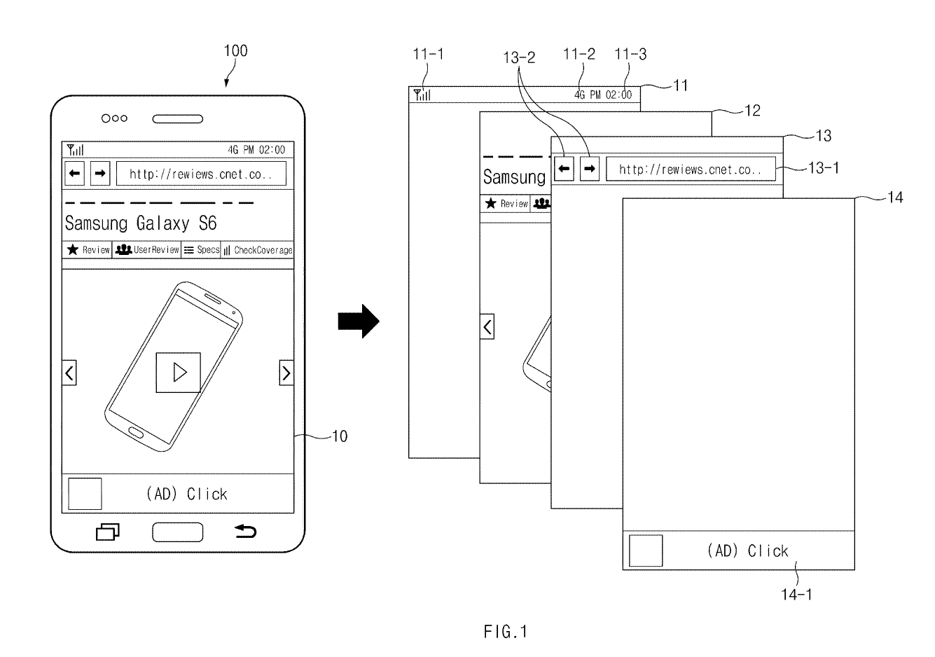

FIGS. 1 through 12, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged services and electronical devices.

Various embodiments of this disclosure may be described with reference to accompanying drawings. Accordingly, those of ordinary skill in the art will recognize that modification, equivalent, and/or alternative on the various embodiments described herein can be variously made without departing from the scope and spirit of this disclosure. With regard to description of drawings, similar components may be marked by similar reference numerals.

In this disclosure disclosed herein, the expressions “have”, “may have”, “include” and “comprise”, or “may include” and “may comprise” used herein indicate existence of corresponding features (e.g., elements such as numeric values, functions, operations, or components) but do not exclude presence of additional features.

In this disclosure disclosed herein, the expressions “A or B”, “at least one of A or/and B”, or “one or more of A or/and B”, and the like used herein may include any and all combinations of one or more of the associated listed items. For example, the term “A or B”, “at least one of A and B”, or “at least one of A or B” may refer to when at least one A is included, when at least one B is included, or when both of at least one A and at least one B are included.

The terms, such as “first”, “second”, and the like used herein may refer to various elements of various embodiments of this disclosure, but do not limit the elements. For example, “a first user device” and “a second user device” indicate different user devices regardless of the order or priority. For example, “a first user device” and “a second user device” indicate different user devices. For example, without departing the scope of this disclosure, a first element may be referred to as a second element, and similarly, a second element may be referred to as a first element.

It will be understood that when an element (e.g., a first element) is referred to as being “(operatively or communicatively) coupled with/to” or “connected to” another element (e.g., a second element), it may be directly coupled with/to or connected to the other element or an intervening element (e.g., a third element) may be present. In contrast, when an element (e.g., a first element) is referred to as being “directly coupled with/to” or “directly connected to” another element (e.g., a second element), it should be understood that there are no intervening element (e.g., a third element).

According to the situation, the expression “configured to” used herein may be used as, for example, the expression “suitable for”, “having the capacity to”, “designed to”, “adapted to”, “made to”, or “capable of”. The term “configured to” must not mean only “specifically designed to” in hardware. Instead, the expression “a device configured to” may mean that the device is “capable of” operating together with another device or other components. CPU, for example, a “processor configured to perform A, B, and C” may mean a dedicated processor (e.g., an embedded processor) for performing a corresponding operation or a generic-purpose processor (e.g., a central processing unit (CPU) or an application processor) which may perform corresponding operations by executing one or more software programs which are stored in a memory device.

Terms used in this disclosure are used to describe specified embodiments of this disclosure and are not intended to limit the scope of this disclosure. The terms of a singular form may include plural forms unless otherwise specified. All the terms used herein, which include technical or scientific terms, may have the same meaning that is generally understood by a person skilled in the art. It will be further understood that terms, which are defined in a dictionary and commonly used, should also be interpreted as is customary in the relevant related art and not in an idealized or overly formal detect unless expressly so defined herein in various embodiments of this disclosure. In some examples, even if terms are terms which are defined in the specification, they may not be interpreted to exclude embodiments of this disclosure.

An electronic device according to various embodiments of this disclosure may include at least one of smartphones, tablet personal computers (PCs), mobile phones, video telephones, electronic book readers, desktop PCs, laptop PCs, netbook computers, workstations, servers, personal digital assistants (PDAs), portable multimedia players (PMPs), Motion Picture Experts Group (MPEG-1 or MPEG-2) Audio Layer 3 (MP3) players, mobile medical devices, cameras, or wearable devices. According to various embodiments, the wearable device may include at least one of an accessory type (e.g., watches, rings, bracelets, anklets, necklaces, glasses, contact lens, or head-mounted-devices (HMDs), a fabric or garment-integrated type (e.g., an electronic apparel), a body-attached type (e.g., a skin pad or tattoos), or an implantable type (e.g., an implantable circuit).

According to an embodiment, the electronic device may be a home appliance. The home appliances may include at least one of, for example, televisions (TVs), digital versatile disc (DVD) players, audios, refrigerators, air conditioners, cleaners, ovens, microwave ovens, washing machines, air cleaners, set-top boxes, TV boxes (e.g., Samsung HomeSync™, Apple TV™, or Google TV™), game consoles (e.g., Xbox™ and PlayStation™), electronic dictionaries, electronic keys, camcorders, electronic picture frames, and the like.

According to another embodiment, the electronic devices may include at least one of medical devices (e.g., various portable medical measurement devices (e.g., a blood glucose monitoring device, a heartbeat measuring device, a blood pressure measuring device, a body temperature measuring device, and the like)), a magnetic resonance angiography (MRA), a magnetic resonance imaging (MRI), a computed tomography (CT), scanners, and ultrasonic devices), navigation devices, global navigation satellite system (GNSS) receivers, event data recorders (EDRs), flight data recorders (FDRs), vehicle infotainment devices, electronic equipment for vessels (e.g., navigation systems and gyrocompasses), avionics, security devices, head units for vehicles, industrial or home robots, automatic teller's machines (ATMs), points of sales (POSs), or internet of things (e.g., light bulbs, various sensors, electric or gas meters, sprinkler devices, fire alarms, thermostats, street lamps, toasters, exercise equipment, hot water tanks, heaters, boilers, and the like).

According to an embodiment, the electronic devices may include at least one of parts of furniture or buildings/structures, electronic boards, electronic signature receiving devices, projectors, or various measuring instruments (e.g., water meters, electricity meters, gas meters, or wave meters, and the like). According to various embodiments, the electronic device may be one of the above-described devices or a combination thereof. An electronic device according to an embodiment may be a flexible electronic device. Furthermore, an electronic device according to an embodiment of this disclosure may not be limited to the above-described electronic devices and may include other electronic devices and new electronic devices according to the development of technologies.

Hereinafter, electronic devices according to various embodiments will be described with reference to the accompanying drawings. The term “user” used herein may refer to a person who uses an electronic device or may refer to a device (e.g., an artificial intelligence electronic device) that uses an electronic device.

FIG. 1 is a drawing for describing a view, according to various embodiments of this disclosure.

Referring to FIG. 1, a screen 10 (or an image frame in terms of a display) corresponding to at least one application (e.g., a web browser, or the like) is output in a display of an electronic device 100. The screen 10 is composed by hierarchically merging a plurality of views 11 to 14.

For example, the first view 11 may be rendered according in response to execution of, for example, a notification manager. For example, an icon 11-1 indicating signal strength between a base station and the electronic device 100, an icon 11-2 indicating cellular data communication, and an icon 11-3 indicating a time may be included in the first view 11.

For example, the second view 12 may be rendered according to execution of a web browser. The second view 12 may compose a part of an activity screen of the web browser. Content of a web page rendered by, for example, the web browser may be included in the second view 12.

For example, the third view 13 may be rendered according to the execution of the web browser. The third view 13 may compose a part of the activity screen of the web browser. In the third view 13, for example, an address bar 13-1, a button 13-2 associated with a web page transition, and the like of the web browser may be included.

For example, the fourth view 14 may be rendered according to the execution of the web browser. The fourth view 14 may compose a part of the activity screen of the web browser. In the fourth view 14, for example, an advertisement image 14-1 rendered by the web browser, and the like may be included.

The first to fourth views 11 to 14 are not substantially limited thereto due to a name thereof. For example, the “view” may be used as a surface or a layer. In addition, each of the views may include, for example, a text, an image, a video, an icon, a UI symbol, or a combination thereof.

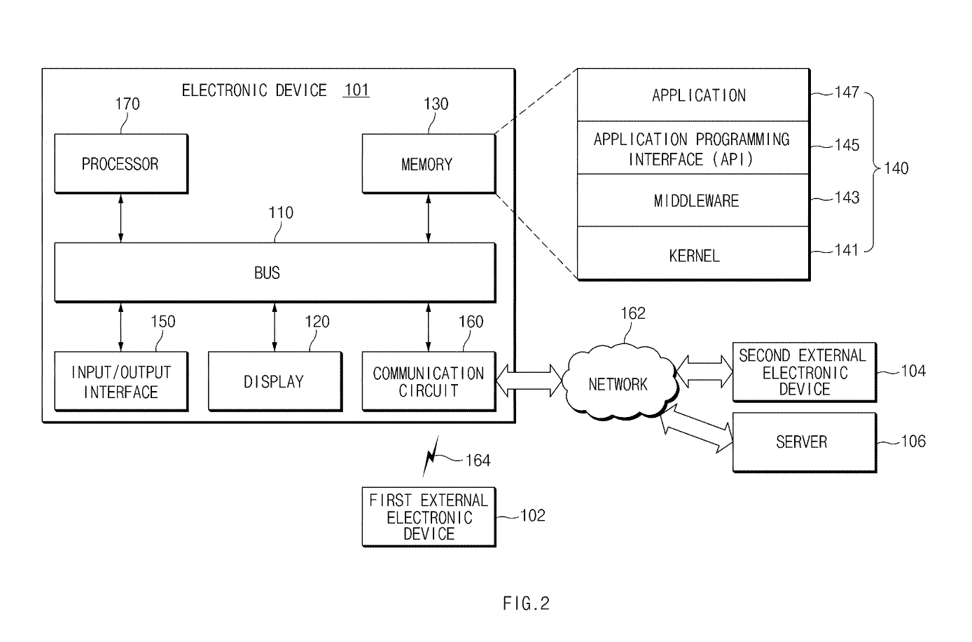

FIG. 2 illustrates a block diagram of an electronic device, according to various embodiments of this disclosure.

Referring to FIG. 2, according to various embodiments, an electronic device 101, 102, or 104 or a server 106 may be connected with each other over a network 162 or a local area network 164. The electronic device 101 may include a bus 110, a display 120, a memory 130, an input/output interface 150, a communication circuit 160, and a processor 170. According to an embodiment, the electronic device 101 may not include at least one of the above-described elements or may further include other element(s).

The bus 110 may be, for example, a circuit which connects the elements 110 to 170 with each other and sends communication (e.g., a control message and/or data) between the elements.

The display 120 may include, for example, a liquid crystal display (LCD), a light-emitting diode (LED) display, an organic LED (OLED) display, a microelectromechanical systems (MEMS) display, or an electronic paper display.

The display 120 may be operatively connected with, for example, the processor 170 and may display various kinds of content (e.g., a text, an image, a video, an icon, a symbol, or the like) for a user based on an image frame (e.g., an (activity) screen) received from the processor 170. The display 120 may include a touch screen and may receive, for example, a touch, gesture, proximity, or hovering input using an electronic pen or a part of the user's body. According to an embodiment, the display 120 may include a pressure sensor (or a “force sensor”) that is capable of measuring the intensity of pressure on the touch of the user. The pressure sensor may be integrated with the display 120 or may be implemented with one or more sensors that are independent of the display 120.

The memory 130 may include a volatile and/or nonvolatile memory. For example, the memory 130 may store instructions or data associated with at least one other element(s) of the electronic device 101. According to an embodiment, the memory 130 may store information about at least one view. For example, the memory 130 may include a plurality of buffers that store a plurality of views rendered by the processor 170.

According to various embodiments, the memory 130 may store software and/or a program 140.

The program 140 may include, for example, a kernel 141, a middleware 143, an application programming interface (API) 145, and/or an application program (or an “application”) 147. At least a part of the kernel 141, the middleware 143, or the API 145 may be referred to as an “operating system (OS)”.

For example, the kernel 141 may control or manage system resources (e.g., the bus 110, the processor 170, the memory 130, and the like) that are used to execute operations or functions of other programs (e.g., the middleware 143, the API 145, and the application program 147). Furthermore, the kernel 141 may provide an interface that allows the middleware 143, the API 145, or the application program 147 to access discrete components of the electronic device 101 so as to control or manage system resources.

The middleware 143 may perform, for example, a mediation role such that the API 145 or the application program 147 communicates with the kernel 141 to exchange data.

Furthermore, the middleware 143 may process one or more task requests received from the application program 147 according to a priority. For example, the middleware 143 may assign the priority, which makes it possible to use a system resource (e.g., the bus 110, the processor 170, the memory 130, or the like) of the electronic device 101, to at least one of the application program 147. For example, the middleware 143 may process the one or more task requests according to the priority assigned to the at least one, which makes it possible to perform scheduling or load balancing on the one or more task requests.

The API 145 may be, for example, an interface through which the application program 147 controls a function provided by the kernel 141 or the middleware 143, and may include, for example, at least one interface or function (e.g., an instruction) for a file control, a window control, image processing, a character control, or the like.

The input/output interface 150 may provide an interface that allows the electronic device 101 to be operatively connected with the external electronic device 102. For example, the input/output interface 150 may transmit an instruction or data, input from a user or another external device, to other element(s) of the electronic device 101. Furthermore, the input/output interface 150 may output an instruction or data, received from other component(s) of the electronic device 101, to a user or another external device.

The communication circuit 160 may establish communication between the electronic device 101 and an external device (e.g., the first external electronic device 102, the second external electronic device 104, or the server 106). For example, the communication circuit 160 may be connected to the network 162 through wireless communication or wired communication to communicate with the external device (e.g., the second external device 104 or the server 106).

The wireless communication may use, for example, at least one of long term evolution (LTE), LTE-advanced (LTE-A), code division multiple access (CDMA), wideband CDMA (WCDMA), universal mobile telecommunications system (UMTS), wireless broadband (WiBro), or global system for mobile communications (GSM), as a cellular communication protocol. Furthermore, the wireless communication may include, for example, the local area network 164. The local area network 164 may include at least one of, for example, a wireless fidelity (Wi-Fi), a Bluetooth, a near field communication (NFC), a magnetic secure transmission (MST), or a global navigation satellite system (GNSS).

The MST may generate a pulse based on transmission data by using an electromagnetic signal, and the pulse may generate a magnetic field signal. The electronic device 101 may send the magnetic field signal to point of sale (POS). The POS may detect the magnetic field signal using a MST reader and may recover the data by converting the detected magnetic field signal to an electrical signal.

The GNSS may include at least one of a global positioning system (GPS), a global navigation satellite system (Glonass), a Beidou Navigation Satellite System (hereinafter referred to as “Beidou”), or a European global satellite-based navigation system (Galileo). Hereinafter, “GPS” and “GNSS” may be used interchangeably in this disclosure.

The wired communication may include at least one of, for example, a universal serial bus (USB), a high definition multimedia interface (HDMI), a recommended standard-232 (RS-232), a plain old telephone service (POTS), or the like. The network 162 may include at least one of telecommunications networks, for example, a computer network (e.g., LAN or WAN), an Internet, and a telephone network.

The processor 170 may include one or more of, for example, a central processing unit (CPU), an application processor (AP), a graphic processing unit (GPU), or a communication processor (CP). The processor 170 may perform, for example, data processing or an operation associated with control or communication of at least one other element(s) of the electronic device 101.

According to an embodiment, the processor 170 may render a plurality of views composing an activity screen, which is based on execution of at least one application, and may store the plurality of views in the memory 130. For example, each of the plurality of views may be stored in at least some of a plurality of buffers included in the memory 130.

The processor 170 may generate a first image frame (screen) based on, for example, a first group of views selected from the plurality of views. Next, the processor 170 may output the generated first image frame in the display 120.

According to an embodiment, the first group of views may include at least one view. For example, when the first group of views includes one view, the processor 170 may generate the first image frame based on the one view. As another example, when the first group of views includes two or more views, the processor 170 may generate the first image frame by merging the two or more views. The first group of views may be merged by a compositor that is executed and/or implemented by the processor 170. For example, the compositor may correspond to a surface flinger.

According to an embodiment, the processor 170 may output a user interface (UI), which allows the user to select the first group of views (or a second group of views, a third group of views, or the like), in the display 120. The user may select a view (e.g., the first group of views), which he/she desires, through a UI output in the display 120.

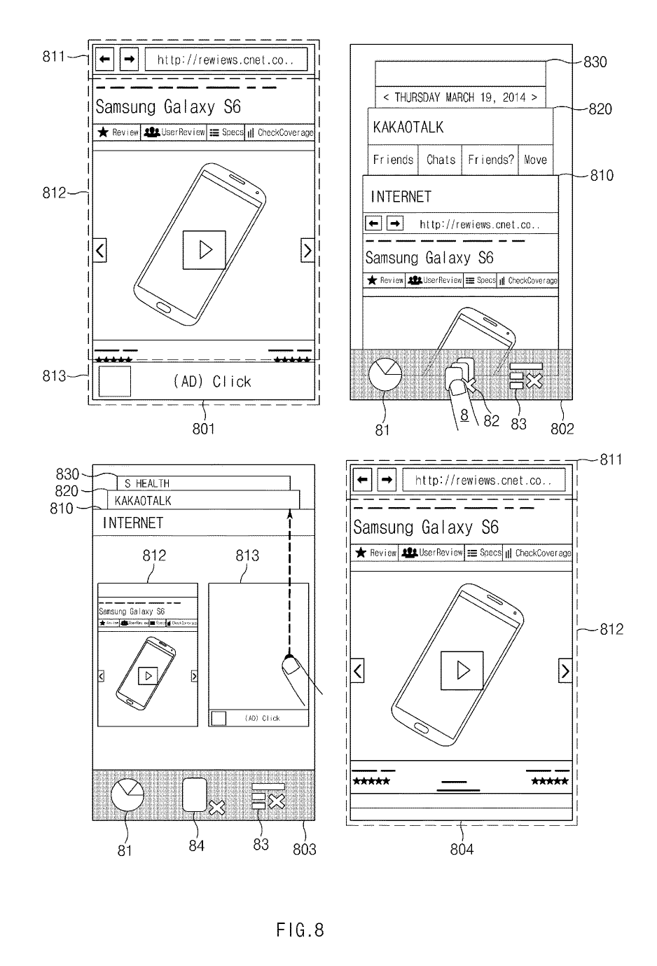

For example, the user may exclude at least some of a plurality of views, which are output through the UI, by using a specified gesture (e.g., a touch swipe, selection of a specified button, or the like). Accordingly, the user may select a view (e.g., the first group of views) that he/she desires. In other words, the first group of views may be selected by excluding, at the user, at least some of the plurality of views by using the UI (refer to FIG. 8).

According to various embodiments, apart from the first group of views, the second group of views and/or the third group of views may be selected by the user. The second group of views and/or the third group of views may include at least one view selected from the plurality of views. The number of the second group of views and/or the number of the third group of views may be the same as or different from the number of the first group of views.

According to an embodiment, the processor 170 may generate a second image frame based on the second group of views selected by the user and may send the second image frame to the external electronic device 102 through the input/output interface 150 (e.g., a USB interface, a HDMI interface, or the like).

According to another embodiment, the processor 170 may generate a third image frame based on the third group of views, which includes at least one view selected by the user, and may send the third image frame to the external electronic device 104 through the communication circuit 160.

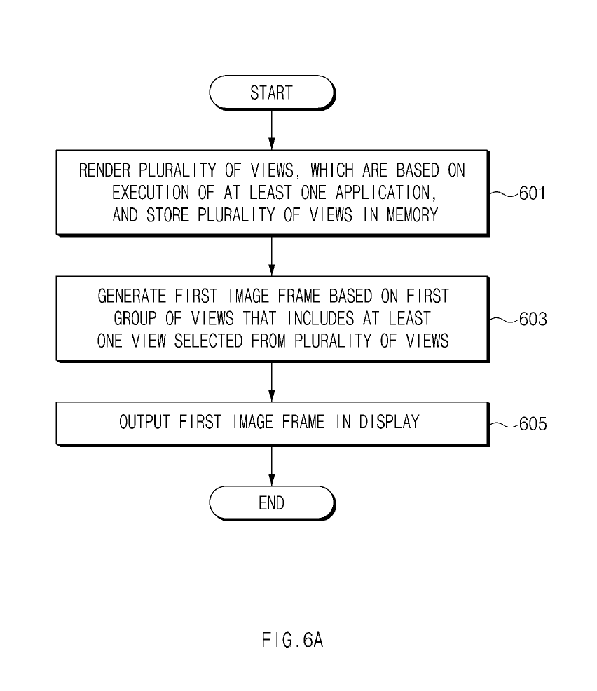

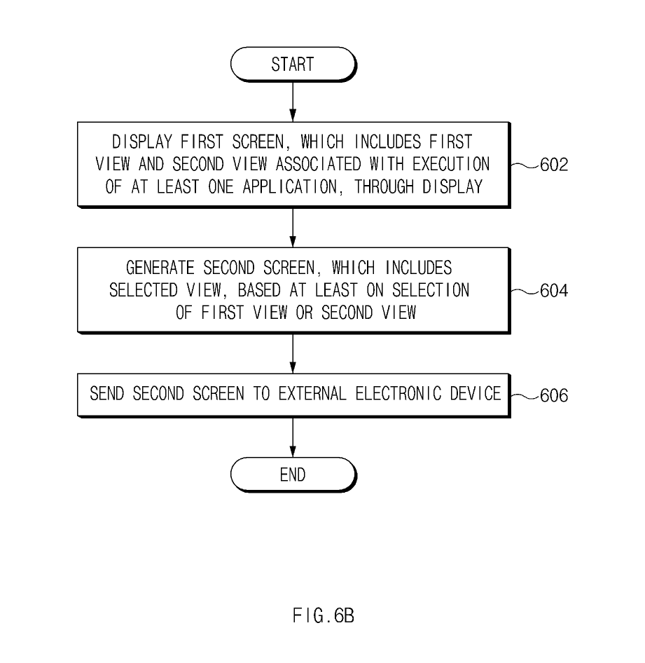

According to various embodiments, the processor 170 may execute various operations described in FIGS. 6A, 6B, 7, and 9. However, an operation of the processor 170 described in FIGS. 6A, 6B, 7, and 9 is not limited to the above-mentioned description as an example. For example, it is understood that the operation of the “processor” described in another part of this disclosure is the operation of the processor 170. In addition, it is understood that at least some of operations described as operations of the electronic device 201 are operations of the processor 170.

Each of the first and second external electronic devices 102 and 104 may be a device of which the type is different from or the same as that of the electronic device 101. According to an embodiment, the server 106 may include a server or a group of two or more servers. According to various embodiments, all or a part of operations that the electronic device 101 will perform may be executed by another or plural electronic devices (e.g., the electronic devices 102 and 104 and the server 106). According to an embodiment, when the electronic device 101 executes any function or service automatically or in response to a request, the electronic device 101 may not perform the function or the service internally, but, alternatively additionally, it may request at least a part of a function associated with the electronic device 101 from other device (e.g., the first or second external electronic device 102 or 104 or the server 106). The other electronic device (e.g., the first or second external electronic device 102 or 104 or the server 106) may execute the requested function or additional function and may transmit the execution result to the electronic device 101. The electronic device 101 may provide the requested function or service using the received result or may additionally process the received result to provide the requested function or service. To this end, for example, cloud computing, distributed computing, or client-server computing may be used.

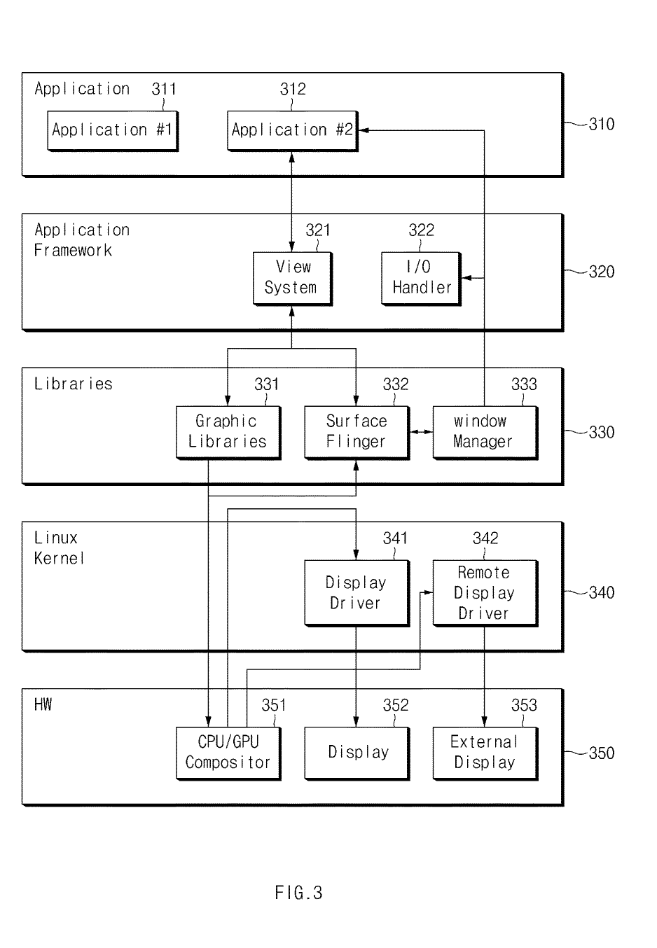

FIG. 3 illustrates a hierarchical block diagram of an electronic device in terms of software, according to an embodiment.

Referring to FIG. 3, according to an embodiment, an electronic device may include an application layer 310, an application framework layer 320, a library layer 330, a kernel (e.g., a Linux kernel) layer 340, and a hardware layer 350. For example, each element of the application layer 310, the application framework layer 320, the library layer 330, and/or the kernel layer 340 may be implemented by interaction between a processor and a memory. It may be understood that an operation of each element included in the layers 310 to 340 is an operation of the processor.

The application layer 310 may include, for example, at least one application (e.g., an application #1 311 or an application #2 312). In FIG. 3, only two applications are illustrated. However, the number of applications and a type of an application are not limited thereto.

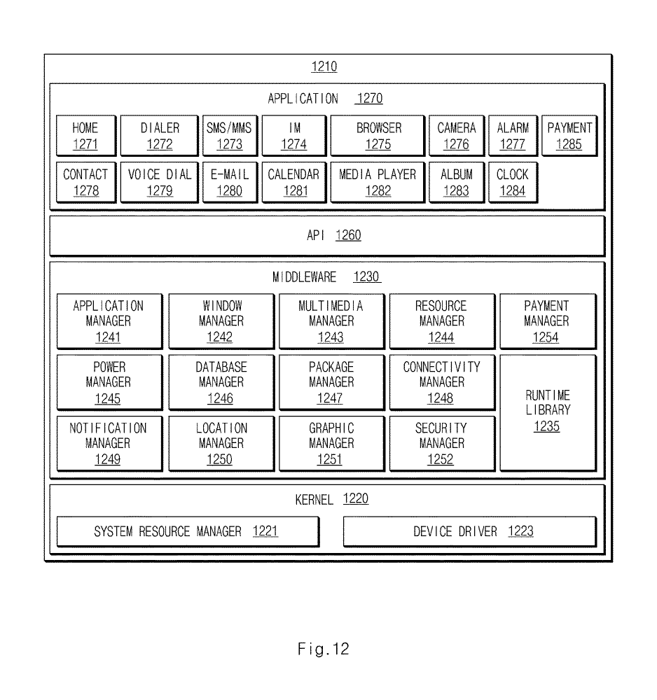

The application framework layer 320 may include, for example, a view system 321 and an I/O handler 322. For example, the applications 311 and 312 may be implemented with a set of views generated by the view system 321. The application framework layer 320 may be included in middleware (e.g., middleware 1230 of FIG. 12) together with the library layer 330 described below.

The library layer 330 may be a common layer that a third party accesses and may include graphic libraries 331, a surface flinger 332 (an example of a compositor), and a window manager 333. For example, each of views (included in an activity screen) of an application may be rendered by using the graphic libraries 331 that include a graphic instruction. The surface flinger 332 may merge or combine two or more views. That is, views rendered by the application may be merged or combined as one image frame for displays 352 and 353 by the surface flinger 332. Each of the views to be combined may be managed (e.g., added, deleted, changed, or the like) by the window manager 333.

The kernel layer 340 may include a display driver 341 and a remote display driver 342. The hardware layer 350 may include a processor 351 (e.g., a CPU, an AP, a GPU, or the like), a display 352, and an external display 353.

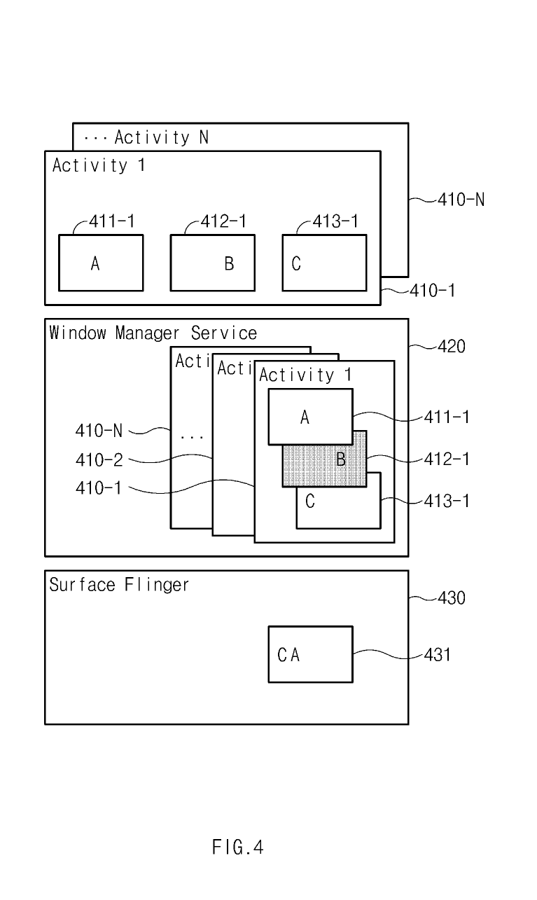

FIG. 4 is a drawing for describing a method for composing a screen, according to an embodiment.

Referring to FIG. 4, activities 410-1 to 410-N output by at least one application, a window manager service 420 provided by a window manager (e.g., the window manager 333 of FIG. 3), and a surface flinger 430 are illustrated.

Each of the ‘N’ activities 410-1 to 410-N output according to execution of at least one application may include at least one view. For example, the activity 410-1 may include a plurality of views 411-1, 412-1, and 413-1.

The plurality of views 411-1, 412-1, and 413-1 may be managed by the window manager service 420. For example, the window manager may add, delete, or change a view that is included in each activity. In addition, the window manager may manage graphic rendering information and a layout of each view.

The surface flinger 430 may generate an image frame 431 by merging or combining views that are managed by the window manager service 420. For example, if the window manager service 420 changes an attribute of the view 412-1 in which ‘B’ is rendered (e.g., excludes a view in which ‘B’ is rendered), the surface flinger 430 may generate the image frame 431 by merging the view 411-1, in which ‘A’ is rendered, with the view 413-1 in which ‘C’ is rendered.

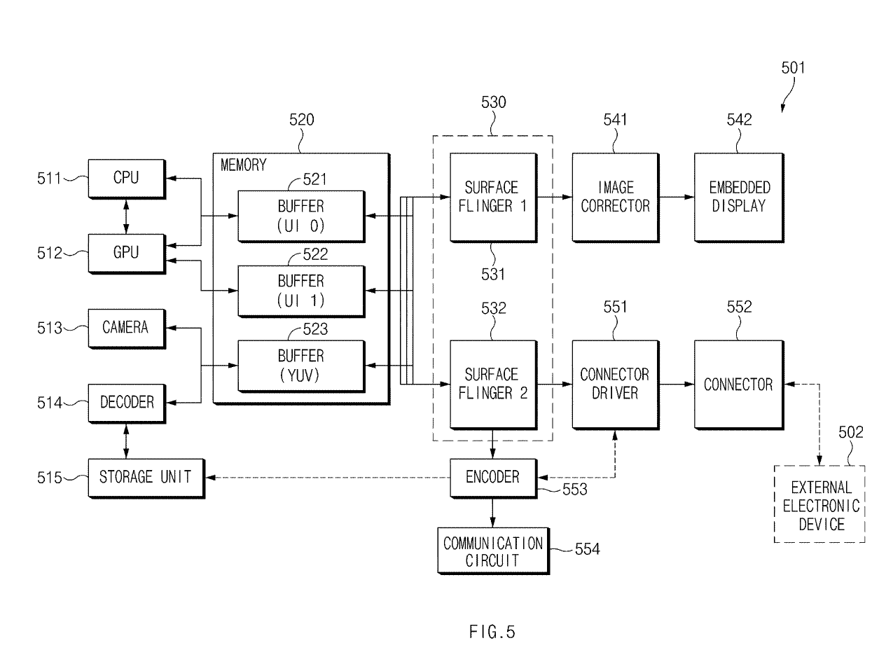

FIG. 5 is a drawing for describing an operation of an electronic device, according to an embodiment.

Referring to FIG. 5, a processor (e.g., a CPU 511, a GPU 512, or the like) may render a view related to an execution screen of an application and may store the view in buffers 521 and 522 of a memory 520. For example, graphic data of the view may be implemented in a red green blue (RGB) format. According to an embodiment, the processor may be implemented with a plurality of processors or may be a single processor (e.g., a general purpose graphics processing unit (GPGPU) or an accelerated massive parallelism (AMP)). Also, for example, video data received through a camera 513 may be stored in a buffer 523 of the memory 520 in a YUV format. After video data read from a storage unit 515 is decoded by a decoder 514, the video data may be stored in the buffer 523 of the memory 520 in the YUV format. According to various embodiments, video data stored in the storage unit 515 may be received from the outside through a communication circuit 554, and the received video data may be encoded by an encoder 553.

The buffers 521 to 523 of the memory 520 may temporarily store image data (or video data) on each view. Each stored view may be sent to a surface flinger 530.

The surface flinger 530 may include, for example, a surface flinger 1 531 for an embedded display 542 and a surface flinger 2 532 for an external electronic device 502.

For example, the surface flinger 1 531 may read a view from at least one of the buffers 521 to 523 of the memory 520 (read the selected first group of views). The surface flinger 1 531 may generate an image frame by merging or combining the read views. The image frame may be provided to the embedded display 542 via, for example, an image corrector 541 (e.g., a gamma corrector).

According to an embodiment, the surface flinger 2 532 may also read a view from at least one of the buffers 521 to 523 of the memory 520 (read the selected second group of views). The surface flinger 2 532 may generate an image frame by merging or combining the read views. The image frame may be provided to the external electronic device 502 through an input/output interface, for example, a connector driver 551 and a connector 552. According to an embodiment, the surface flinger 2 532 may send the generated image frame to the encoder 553. The encoder 553 may encode the image frame based on a specified standard and may send the encoded image frame to an external device through the communication circuit 554.

FIG. 6A illustrates a method for composing a screen, according to an embodiment.

Referring to FIG. 6A, according to an embodiment, the method for composing a screen may include operation 601 to operation 605. Operation 601 to operation 605 may be performed by, for example, the electronic device 101 illustrated in FIG. 2. For example, each operation in operation 601 to operation 605 may be implemented with instructions that are performed (or executed) by the processor 170 of the electronic device 101. The instructions may be stored in, for example, the memory 130 of the electronic device 101. Hereinafter, operation 601 to operation 605 may be described by using the reference numeral of FIG. 2.

In operation 601, the processor 170 of the electronic device 101 may render a plurality of views, which are based on execution of at least one application, and may store the plurality of views in the memory 130. According to an embodiment, the plurality of views may be stored in, for example, a plurality of buffers included in the memory 130. Furthermore, the plurality of views may include, for example, at least a text, an image, a video, a UI symbol, or a combination thereof.

In operation 603, the processor 170 of the electronic device 101 may generate a first image frame based on a first group of views that includes at least one view selected from the plurality of views. For example, when the first group of views includes one view, the processor 170 may generate the first image frame based on the one view. According to an embodiment, when the first group of views includes two or more views, the processor 170 may generate the first image frame by merging the two or more views.

The first group of views may be merged by a surface flinger (an example of a compositor) that is executed and/or implemented by the processor 170. Moreover, in selection (or management) of the selected at least one view, a window manager implemented by the processor 170 may be used.

In operation 605, the processor 170 of the electronic device 101 may output the first image frame, which is generated in operation 603, in the display 120 of the electronic device 101.

According to various embodiments, in operation 603, the processor 170 may select or remove a certain view of the first group of views in a framework layer based on settings of an application, which is being executed, without intervention of a user. For example, when an application (hereinafter called “record application”) configured to record content (e.g., video content or game content) (or send content to the outside in a streaming manner), which is being performed (e.g., played), in real time is executed, the record application may be configured to record only a view in which the content is included. Accordingly, for example, even though a notification pop-up generated by an IM application is output in a display as a new view while the content is being recorded, the notification pop-up may not be recorded. As another example, even though a system pop-up (e.g., a soft-keyboard) or the like generated by an OS is output as a new view, the system pop-up may not be recorded.

According to an embodiment of this disclosure, the user may reconfigure an execution screen of an application, which is displayed in an electronic device, at his/her own preference. For example, when an advertisement that the user does not desire want to see is included in the execution screen (or an image frame) of the application, the user may remove a view, in which the advertisement is included, depending on his/her determination.

FIG. 6B illustrates a method for composing a screen, according to another embodiment.

Referring to FIG. 6B, according to an embodiment, the method for composing a screen may include operation 602 to operation 606. Operation 602 to operation 606 may be performed by, for example, the electronic device 101 illustrated in FIG. 2. Each operation in operation 602 to operation 606 may be implemented with instructions that are performed (or executed) by the processor 170 of the electronic device 101. The instructions may be stored in, for example, a computer recording medium or the memory 130 of the electronic device 101. Hereinafter, operation 602 to operation 606 may be described by using the reference numeral of FIG. 2.

In operation 602, the processor 170 may display a first screen, which includes a first view and a second view associated with execution of at least one application, through the display 120. For example, the first view may include content corresponding to the at least one application, and the second view may correspond to a view associated with the first view.

In operation 604, the processor 170 may generate a second screen, which includes the selected view, based at least on selection of the first view or the second view. For example, the processor 170 may generate the second screen by using a view, which includes content corresponding to the at least one application, from among the first view or the second view. The processor 170 may store, for example, the generated second screen in the memory 130.

According to an embodiment, the processor 170 may select the first view or the second view based at least on a call by a system command of the electronic device 101 or may select the first view or the second view based at least on a user input (e.g., refer to FIG. 8).

In operation 606, the processor 170 may send the second screen, which is generated in operation 604, to the external electronic device 102, 104, or 106 by using the communication circuit 160.

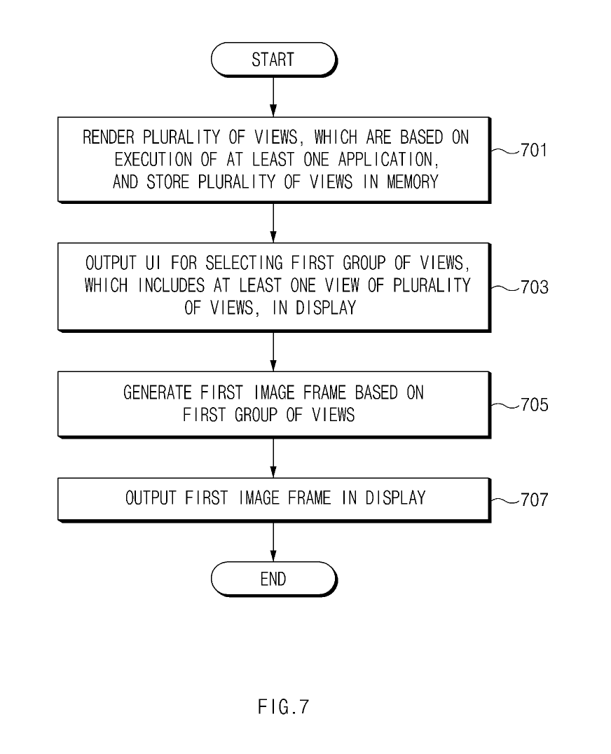

FIG. 7 illustrates a method for composing a screen, according to another embodiment.

Referring to FIG. 7, according to an embodiment, the method for composing a screen may include operation 701 to operation 707. Operation 701 to operation 707 may be performed by, for example, the electronic device 101 illustrated in FIG. 2. Each operation in operation 701 to operation 707 may be implemented with instructions that are performed (or executed) by the processor 170 of the electronic device 101. The instructions may be stored in, for example, computer recording medium or the memory 130 of the electronic device 101. Hereinafter, the reference numeral of FIG. 2 may be used in a description of operation 701 to operation 707. With regard to FIG. 6A, duplicated descriptions may not be repeated here.

In operation 701, the processor 170 of the electronic device 101 may render a plurality of views, which are based on execution of at least one application, and may store the plurality of views in the memory 130.

In operation 703, the processor 170 of the electronic device 101 may output a UI for selecting a first group of views among the plurality of views in a display. A user may select at least one view (e.g., the first group of views), which he/she desires, through the UI. According to an embodiment, the first group of views may be selected by excluding, at the user, at least some of the plurality of views by using the UI (refer to FIG. 8).

In operation 705, the processor 170 of the electronic device 101 may generate a first image frame based on the first group of views. For example, when the first group of views includes one view, the processor 170 may generate the first image frame based on the one view. According to an embodiment, when the first group of views includes two or more views, the processor 170 may generate the first image frame by merging the two or more views by using a surface flinger (an example of a compositor). Moreover, in selection (or management) of the selected at least one view, a window manager may be used.

In operation 707, the processor 170 of the electronic device 101 may output the first image frame in the display 120.

FIG. 8 illustrates screens of an electronic device for describing a screen composing method, according to an embodiment.

Referring to FIG. 8, screens 801 to 804 of a display are illustrated. The screens may be displayed in, for example, the display 120 of the electronic device 101 illustrated in FIG. 2.

The screen 801 may be based on, for example, an activity of a web browser application that is being currently executed. The screen 801 may correspond to an image frame in which three views 811 to 813 (e.g., the second view 12, the third view 13, and the fourth view 14 of FIG. 1) are merged and which is output in the display 120.

For example, like the third view 13 of FIG. 1, an address bar, buttons associated with web page transition, or the like may be displayed in the view 811 of the screen 801, and content of a web page such as the second view 12 of FIG. 1 may be displayed in the view 812. Furthermore, for example, an advertisement image may be displayed in the area 813 like the fourth view 14 of FIG. 1.

According to an embodiment, the screen 802 may be based on an activity of a task manager application. According to an embodiment, application processes 810 to 830, which are being performed in foreground and background in an electronic device, and icons 81 to 83 for managing the application processes may be displayed in the screen 802.

If the user touches the icon 81 by using, for example, a portion of his/her body (e.g., a finger 8), the user may receive a usage status of a memory and/or a list of the applications that is being performed (not illustrated). According to an embodiment, if the user touches the icon 83, the user may end all the application processes that are being performed. According to an embodiment, if the user touches the icon 82, the screen 802 of the electronic device may be changed into the screen 803.

If the icon 82 is selected by the touch, a UI for selecting a first group of views among the plurality of views may be output in the screen 803. The user may select at least one view (e.g., the first group of views), which he/she desires, through the UI.

For example, in the screen 803, the views may be the UI for selecting the first group of views. The views (e.g., the views 811 to 813 composing a screen of a web browser) that compose a screen of an application being performed may be provided to each of the application processes 810 to 830. Moreover, the icons 81 and 83 for managing an application process and the icon 82 for managing views that compose the screen of the application may be further provided to the screen 803.

For example, if the user performs a horizontal touch scroll operation by using a portion of his/her body (e.g., the finger 8), the views 811 to 813 that compose the screen of the web browser may be sequentially displayed. Also, for example the user vertically swipes a certain view by using a portion of his/her body (e.g., the finger 8), the corresponding certain view may be excluded from the views that compose the screen of the web browser. For example, if the user vertically swipes the view 813 by using the finger 8, the view 813 including an advertisement image may be excluded from the views that compose the screen of the web browser. Accordingly, the view 811 and the view 812 may be selected as the first group of views that composes the execution screen of the web browser.

According to various embodiments, if the user touches an icon 84 after touching the view 813, the view 813 may be excluded from the view that composes the execution screen of the web browser. Accordingly, the view 811 and the view 812 may be selected as the first group of views that composes the execution screen of the web browser.

The screen 804 is composed of the first group of views (e.g., the views 811 and 812) that the user selects through a UI output in the screen 803. The screen 804 may correspond to an image frame output on the display, where views (e.g., the view 811 and 812) in the selected first group are merged.

According to an embodiment of this disclosure, the user may intuitively reconfigure an execution screen of an application, which is displayed in the electronic device, by using the UI.

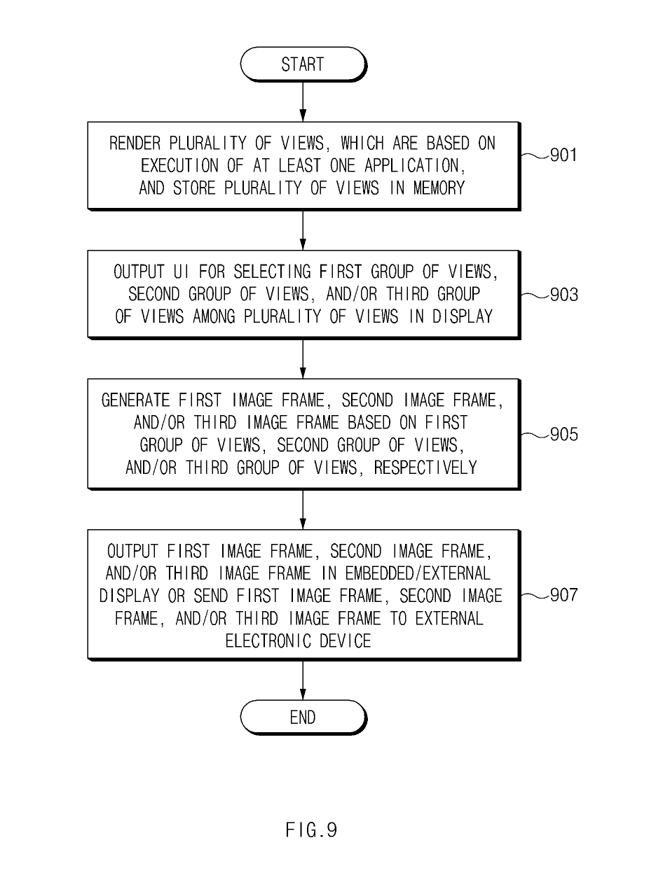

FIG. 9 illustrates a method for describing sharing a screen with a plurality of electronic devices by using a method for composing a screen, according to an embodiment.

Referring to FIG. 9, according to an embodiment, the method for composing a screen may include operation 901 to operation 907. Operation 901 to operation 907 may be performed by, for example, the electronic device 101 illustrated in FIG. 2. Each operation in operation 901 to operation 907 may be implemented with instructions that are performed (or executed) by the processor 170 of the electronic device 101. The instructions may be stored in, for example, computer recording medium or the memory 130 of the electronic device 101. Hereinafter, the reference numeral of FIG. 2 may be used in a description of operation 901 to operation 907. With regard to FIGS. 6A and 7, duplicated descriptions may not be repeated here.

In operation 901, the processor 170 of the electronic device 101 may render a plurality of views, which are based on execution of at least one application, and may store the plurality of views in the memory 130.

In operation 903, the processor 170 of the electronic device 101 may output a UI for selecting a first group of views, a second group of views, and/or a third group of views among the plurality of views in the display 120. The UI for selecting each group of views may have, for example, a form similar to the UI described in FIG. 8.

In operation 905, the processor 170 of the electronic device 101 may generate a first image frame, a second image frame, and/or a third image frame based on the first group of views, the second group of views, and/or the third group of views, respectively.

In operation 907, the processor 170 of the electronic device 101 may output the generated first image frame in the display 120 that is embedded in the electronic device 101. Also, for example, the processor 170 may send the generated second image frame to an external electronic device (e.g., a TV) through the input/output interface 150 (e.g., a USB interface or a HDMI interface). Furthermore, for example, the processor 170 may send the generated third image frame to the external electronic device (e.g., a smartphone, a tablet PC, a desktop PC, a laptop PC, a smart TV), which includes a communication interface, through the communication circuit 160.

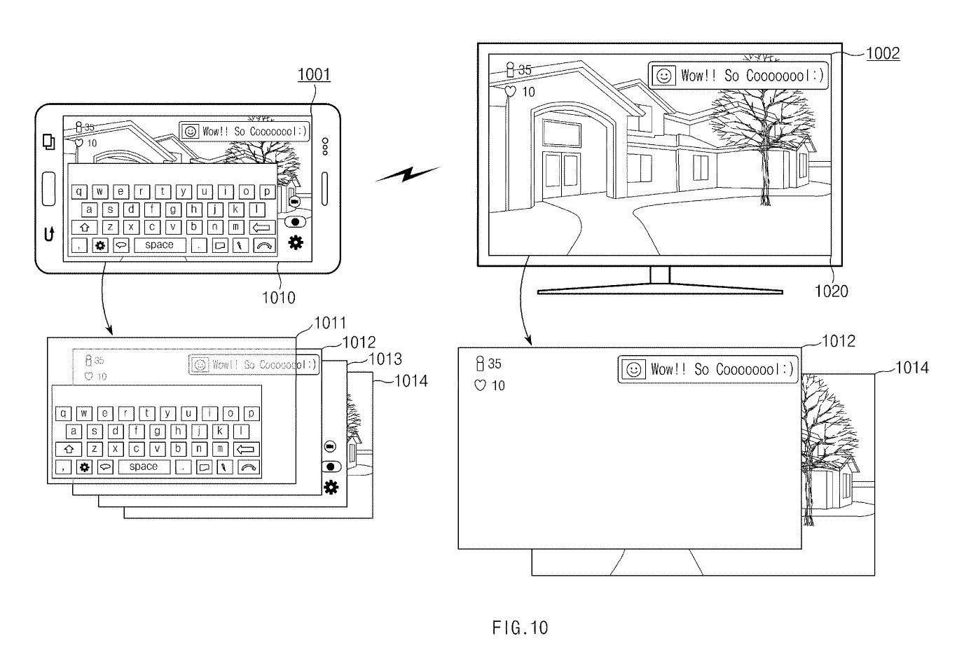

FIG. 10 is a drawing for describing sharing a screen with a plurality of electronic devices by using a method for composing a screen, according to an embodiment.

Referring to FIG. 10, an electronic device 1001 and an external electronic device 1002 may execute an individual broadcasting application. The individual broadcasting application may correspond to an application capable of sending a video, which an individual broadcaster produces, while the individual broadcaster, not a professional producer, exchanges an instant message with unspecified individuals based on Internet in real time.

According to an embodiment, a screen 1010 output in the electronic device 1001 may correspond to a screen output when the individual broadcaster broadcasts by using the individual broadcasting application. The screen 1010 based on execution of the individual broadcasting application is generated by hierarchically merging a plurality of views 1011 to 1014.

For example, a soft-keyboard for a text input may be included in the view 1011, and the instant message exchanged with unspecified individuals in real time may be included in the view 1012. In addition, for example, a soft-key for controlling a camera may be included in the view 1013, and broadcast video content (e.g., video data in a YUV format) obtained through the camera may be included in the view 1014.

According to an embodiment, the electronic device 1001 may perform a method for sharing a screen that is described in FIG. 9. For example, a user (the individual broadcaster) of the electronic device 1001 may select a first group of views, which he/she desires to receive, and a second group of views or a third group of views, which another person will receive, from among the views 1011 to 1014 by using a specified UI (refer to FIG. 8).

For example, if the user (the individual broadcaster) selected the four views 1011 to 1014 as the first group of views, the screen 1010 in which the four views 1011 to 1014 are merged may be output in the electronic device 1001 of the user. Furthermore, if the user (the individual broadcaster) selected the two views 1012 and 1014 as the second group of views or the third group of views, the screen 1020 in which the two views 1012 and 1014 are merged may be output in the electronic device 1002 of another person that watches the individual broadcasting.

According to various embodiments, the electronic device 1002 (hereinafter called “receiving-side electronic device”) of another person may include only some views, which are in a screen (composed of a plurality of views) received from the electronic device 1001 (hereinafter called “sending-side electronic device”) of the individual broadcaster, in an output screen. For example, when the user selects the view 1014, the receiving-side electronic device 1002 may display the an output screen in a display after designating only the view 1014, which the user selects, as the output screen in the screen 1020 in which the views 1012 and 1014 are merged. Accordingly, the view 1012 may not be output by the receiving-side electronic device 1002.

According to an embodiment, the receiving-side electronic device 1002 may automatically remove a view including specified content (e.g., advertisement, adult content, or the like) in a screen (composed of a plurality of views) received from the sending-side electronic device 1001.

According to an embodiment of this disclosure, the user may reconfigure an execution screen of an external electronic device, which shares the execution screen of the application, as well as the execution screen of the application displayed in his/her electronic device at his/her own preference. This may mean that the user is capable of removing a view including unnecessary content or content that he/she does not desire to share.

In addition, according to an embodiment, even though a developer of the application expects that the execution screen of the application is output in a plurality of electronic devices, there is no need to configure an activity screen such that the activity screen is suitable for the plurality of electronic devices.

Furthermore, according to an embodiment, the electronic device may generate an image frame to be provided to the external electronic device by using a view that is rendered for the image frame to be provided to an embedded display. Accordingly, the electronic device may not repeatedly render the view of the image frame to be provided to the external electronic device. Accordingly, a power resource and a computing resource that are unnecessary may be restrained from being used.

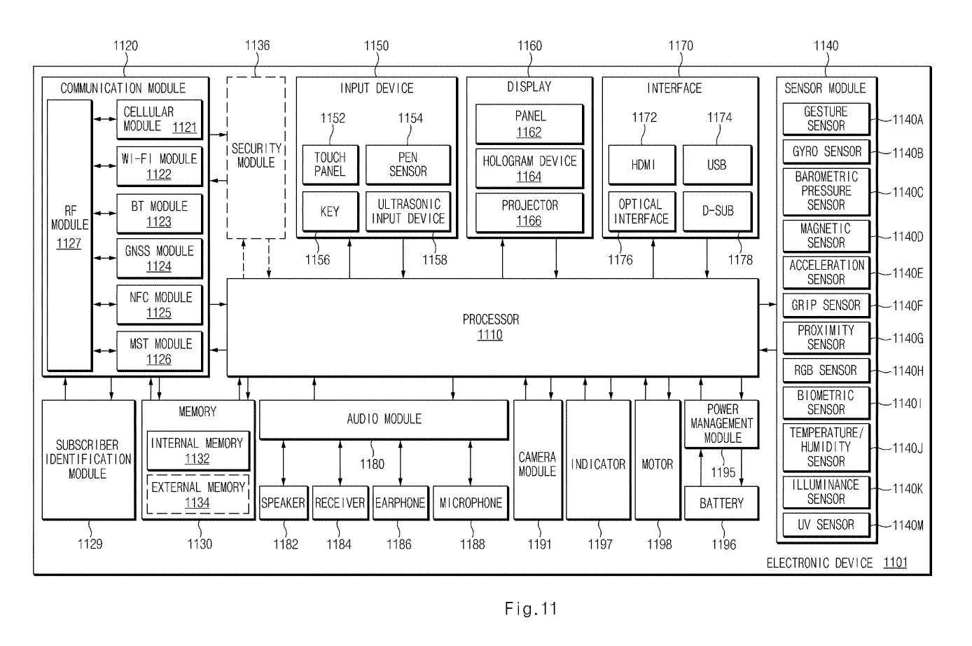

FIG. 11 illustrates a block diagram of an electronic device, according to various embodiments.

Referring to FIG. 11, an electronic device 1101 may include, for example, all or a part of the electronic device 101 illustrated in FIG. 2. The electronic device 1101 may include one or more processors (e.g., an application processor (AP)) 1110, a communication module 1120, a subscriber identification module 1124, a memory 1130, a sensor module 1140, an input device 1150, a display 1160, an interface 1170, an audio module 1180, a camera module 1191, a power management module 1195, a battery 1196, an indicator 1197, and a motor 1198.

The processor 1110 may drive an operating system (OS) or an application program to control a plurality of hardware or software elements connected to the processor 1110 and may process and compute a variety of data. For example, the processor 1110 may be implemented with a system on chip (SoC). According to an embodiment, the processor 1110 may further include a graphic processing unit (GPU) and/or an image signal processor (ISP). The processor 1110 may include at least a part (e.g., a cellular module 1121) of elements illustrated in FIG. 2. The processor 1110 may load and process an instruction or data, which is received from at least one of other elements (e.g., a nonvolatile memory) and may store a variety of data in a nonvolatile memory.

The communication module 1120 may be configured the same as or similar to a communication circuit 160 of FIG. 2. The communication module 1120 may include a cellular module 1121, a Wi-Fi module 1122, a Bluetooth (BT) module 1123, a GNSS module 1124 (e.g., a GPS module, a Glonass module, a Beidou module, or a Galileo module), a near field communication (NFC) module 1125, a MST module 1126, and a radio frequency (RF) module 1127.

The cellular module 1121 may provide a voice call, a video call, a character service, an Internet service, or the like over a communication network. According to an embodiment, the cellular module 1121 may perform discrimination and authentication of the electronic device 1101 within a communication network using the subscriber identification module 1129 (e.g., a SIM card). According to an embodiment, the cellular module 1121 may perform at least a part of functions that the processor 1110 provides. According to an embodiment, the cellular module 1121 may include a communication processor (CP).

Each of the Wi-Fi module 1122, the BT module 1123, the GNSS module 1124, the NFC module 1125, or the MST module 1126 may include a processor that processes data exchanged through a corresponding module, for example. According to an embodiment, at least a part (e.g., two or more elements) of the cellular module 1121, the Wi-Fi module 1122, the BT module 1123, the GNSS module 1124, the NFC module 1125, or the MST module 1126 may be included within one Integrated Circuit (IC) or an IC package.

The RF module 1127 may send and receive, for example, a communication signal (e.g., an RF signal). For example, the RF module 1127 may include a transceiver, a power amplifier module (PAM), a frequency filter, a low noise amplifier (LNA), an antenna, or the like. According to another embodiment, at least one of the cellular module 1121, the Wi-Fi module 1122, the BT module 1123, the GNSS module 1124, the NFC module 1125, or the MST module 1126 may send and receive an RF signal through a separate RF module.

The subscriber identification module 1129 may include, for example, a card and/or embedded SIM which includes a subscriber identification module and may include unique identification information (e.g., integrated circuit card identifier (ICCID)) or subscriber information (e.g., integrated mobile subscriber identity (IMSI)).

The memory 1130 (e.g., the memory 130) may include an internal memory 1132 or an external memory 1134. For example, the internal memory 1132 may include at least one of a volatile memory (e.g., a dynamic random access memory (DRAM), a static RAM (SRAM), or a synchronous DRAM (SDRAM)), a nonvolatile memory (e.g., a one-time programmable read only memory (OTPROM), a programmable ROM (PROM), an erasable and programmable ROM (EPROM), an electrically erasable and programmable ROM (EEPROM), a mask ROM, a flash ROM, a NAND flash memory, or a NOR flash memory), a hard drive, or a solid state drive (SSD).

The external memory 1134 may further include a flash drive such as compact flash (CF), secure digital (SD), micro secure digital (Micro-SD), mini secure digital (Mini-SD), extreme digital (xD), a multimedia card (MMC), a memory stick, or the like. The external memory 1134 may be operatively and/or physically connected with the electronic device 1101 through various interfaces.

The security module 1136 may be a module that includes a storage space of which the security level is higher than that of the memory 1130 and may be a circuit that provides safe data storage and a protected execution environment. The security module 1136 may be implemented with a separate circuit and may include a separate processor. For example, the security module 1136 may be in a smart chip or a secure digital (SD) card, which is removable, or may include an embedded secure element (eSE) embedded in a fixed chip of the electronic device 1101. Furthermore, the security module 1136 may operate based on an operating system (OS) that is different from the OS of the electronic device 1101. For example, the security module 1136 may operate based on java card open platform (JCOP) OS.

The sensor module 1140 may measure, for example, a physical quantity or may detect an operation state of the electronic device 1101. The sensor module 1140 may convert the measured or detected information to an electric signal. For example, the sensor module 1140 may include at least one of, for example, a gesture sensor 1140A, a gyro sensor 1140B, a pressure sensor 1140C, a magnetic sensor 1140D, an acceleration sensor 1140E, a grip sensor 1140F, a proximity sensor 1140G, a color sensor 1140H (e.g., a red, green, blue (RGB) sensor), a biometric sensor 1140I, a temperature/humidity sensor 1140J, an illuminance sensor 1140K, or an ultra violet (UV) sensor 1140M. Additionally or generally, the sensor module 1140 may further include, for example, an E-nose sensor, an electromyography sensor (EMG) sensor, an electroencephalogram (EEG) sensor, an electrocardiogram (ECG) sensor, an infrared (IR) sensor, an iris sensor, and/or a fingerprint sensor. The sensor module 1140 may further include a control circuit that controls at least one or more sensors included therein. According to an embodiment, the electronic device 1101 may further include a processor which is a part of the processor 1110 or independent of the processor 1110 and is configured to control the sensor module 1140. The processor may control the sensor module 1140 while the processor 1110 remains at a sleep state.

The input device 1150 may include, for example, a touch panel 1152, a (digital) pen sensor 1154, a key 1156, or an ultrasonic input device 1158. The touch panel 1152 may use at least one of capacitive, resistive, infrared and ultrasonic detecting methods. Also, the touch panel 1152 may further include a control circuit. The touch panel 1152 may further include a tactile layer to provide a tactile reaction to a user.

The (digital) pen sensor 1154 may be, for example, a part of a touch panel or may include an additional sheet for recognition. The key 1156 may include, for example, a physical button, an optical key, a keypad, and the like. The ultrasonic input device 1158 may detect (or sense) an ultrasonic signal, which is generated from an input device, through a microphone (e.g., a microphone 1188) and may check data corresponding to the detected ultrasonic signal. According to an embodiment, the panel 1152 may include a pressure sensor (or a force sensor) that is capable of measuring the intensity of pressure on the touch of a user. The pressure sensor may be implemented with a combination with the touch panel 1152 or may be implemented with one or more sensors that are independent of the touch panel 1152.

The display 1160 (e.g., the display 120) may include a panel 1162, a hologram device 1164, or a projector 1166. The panel 1162 may be configured the same as or similar to the display 120 of FIG. 2. The panel 1162 may be implemented to be flexible, transparent or wearable, for example. The panel 1162 and the touch panel 1152 may be integrated into a single module. The hologram device 1164 may display a stereoscopic image in a space by using a light interference phenomenon. The projector 1166 may project light onto a screen so as to display an image. The screen may be arranged inside or outside the electronic device 1101. According to an embodiment, the display 1160 may further include a control circuit that controls the panel 1162, the hologram device 1164, or the projector 1166.

The interface 1170 may include, for example, a high-definition multimedia interface (HDMI) 1172, a universal serial bus (USB) 1174, an optical interface 1176, or a D-subminiature (D-sub) 1178. The interface 1170 may be included, for example, in the communication circuit 160 illustrated in FIG. 2. Additionally or generally, the interface 1170 may include, for example, a mobile high definition link (MHL) interface, a SD card/multi-media card (MMC) interface, or an infrared data association (IrDA) standard interface.

The audio module 1180 may convert a sound and an electric signal in dual directions. At least a part of the audio module 1180 may be included, for example, in the input/output interface 150 illustrated in FIG. 2. The audio module 1180 may process, for example, sound information that is input or output through a speaker 1182, a receiver 1184, an earphone 1186, or a microphone 1188.

The camera module 1191 that shoots a still image or a video may include, for example, at least one image sensor (e.g., a front sensor or a rear sensor), a lens, an image signal processor (ISP), or a flash (e.g., an LED or a xenon lamp).

The power management module 1195 may manage, for example, power of the electronic device 1101. According to an embodiment, a power management integrated circuit (PMIC) a charger IC, or a battery or fuel gauge may be included in the power management module 1195. The PMIC may have a wired charging method and/or a wireless charging method. The wireless charging method may include, for example, a magnetic resonance method, a magnetic induction method or an electromagnetic method and may further include an additional circuit, for example, a coil loop, a resonant circuit, or a rectifier, and the like. The battery gauge may measure, for example, a remaining capacity of the battery 1196 and a voltage, current or temperature thereof while the battery is charged. The battery 1196 may include, for example, a rechargeable battery or a solar battery.

The indicator 1197 may display a specific state of the electronic device 1101 or a part thereof (e.g., the processor 1110), such as a booting state, a message state, a charging state, and the like. The motor 1198 may convert an electrical signal into a mechanical vibration and may generate the following effects: vibration, haptic, and the like. Although not illustrated, the electronic device 1101 may include a processing device (e.g., a GPU) that supports a mobile TV. The processing device that supports a mobile TV may process media data according to the standards of digital multimedia broadcasting (DMB), digital video broadcasting (DVB), MediaFlo™, or the like.

Each of the above-mentioned elements of the electronic device described in this disclosure may be configured with one or more components, and the names of the elements may be changed according to the type of the electronic device. According to various embodiments, the electronic device may include at least one of the above-mentioned elements, and some elements may be omitted or other additional elements may be added. Furthermore, some of the elements of the electronic device according to various embodiments may be combined with each other so as to form one entity, such that the functions of the elements may be performed in the same manner as before the combination.

FIG. 12 illustrates a block diagram of a program module, according to various embodiments.

Referring to FIG. 12, a program module 1210 (e.g., the program 140) may include an operating system (OS) to control resources associated with an electronic device (e.g., the electronic device 101), and/or diverse applications (e.g., the application program 147) driven on the OS. The OS may be, for example, Android™, iOS™, Windows™, Symbian™, Tizen™, or Samsung Bada OS™.

The program module 1210 may include a kernel 1220, a middleware 1230, an application programming interface (API) 1260, and/or an application 1270. At least a part of the program module 1210 may be preloaded on an electronic device or may be downloadable from an external electronic device (e.g., the electronic device 102 or 104, the server 106, and the like).

The kernel 1220 (e.g., the kernel 141) may include, for example, a system resource manager 1221, or a device driver 1223. The system resource manager 1221 may control, allocate, or retrieve system resources. According to an embodiment, the system resource manager 1221 may include a process managing part, a memory managing part, a file system managing part, or the like. The device driver 1223 may include, for example, a display driver, a camera driver, a Bluetooth driver, a common memory driver, an USB driver, a keypad driver, a Wi-Fi driver, an audio driver, or an inter-process communication (IPC) driver.

The middleware 1230 may provide, for example, a function which the application 1270 needs in common or may provide diverse functions to the application 1270 through the API 1260 to allow the application 1270 to efficiently use limited system resources of the electronic device. According to an embodiment, the middleware 1230 (e.g., the middleware 143) may include at least one of a runtime library 1235, an application manager 1241, a window manager 1242, a multimedia manager 1243, a resource manager 1244, a power manager 1245, a database manager 1246, a package manager 1247, a connectivity manager 1248, a notification manager 1249, a location manager 1250, a graphic manager 1251, or a security manager 1252, or a payment manager 1254.

The runtime library 1235 may include, for example, a library module which is used by a compiler to add a new function through a programming language while the application 1270 is being executed. The runtime library 1235 may perform input/output management, memory management, or capacities about arithmetic functions.

The application manager 1241 may manage, for example, a life cycle of at least one application of the application 1270. The window manager 1242 may manage a graphic user interface (GUI) resource which is used in a screen. The multimedia manager 1243 may identify a format necessary for playing diverse media files, and may perform encoding or decoding of media files by using a codec suitable for the format. The resource manager 1244 may manage resources such as a storage space, a memory, or a source code of at least one application of the application 1270.

The power manager 1245 may operate, for example, with a basic input/output system (BIOS) to manage a battery or power, and may provide power information for an operation of an electronic device. The database manager 1246 may generate, search for, or modify database which is to be used in at least one application of the application 1270. The package manager 1247 may install or update an application which is distributed in the form of a package file.

The connectivity manager 1248 may manage, for example, a wireless connection such as Wi-Fi or Bluetooth. The notification manager 1249 may display or notify an event such as arrival message, appointment, or proximity notification in a mode that does not disturb a user. The location manager 1250 may manage location information of an electronic device. The graphic manager 1251 may manage a graphic effect that is provided to a user, or manage a user interface relevant thereto. The security manager 1252 may provide a general security function necessary for system security, user authentication, or the like. According to an embodiment of this disclosure, when an electronic device (e.g., the electronic device 101) includes a telephony function, the middleware 1230 may further includes a telephony manager for managing a voice or video call function of the electronic device.

The middleware 1230 may include a middleware module that combines diverse functions of the above-described elements. The middleware 1230 may provide a module specialized to each OS kind to provide differentiated functions. In addition, the middleware 1230 may remove a part of the preexisting elements, dynamically, or may add new elements thereto.

The API 1260 (e.g., the API 145) may be, for example, a set of programming functions and may be provided with a configuration which is variable depending on an OS. For example, when an OS is Android™ or iOS™, it may provide one API set per platform. When an OS is Tizen™, it may provide two or more API sets per platform.

The application 1270 (e.g., the application program 147) may include, for example, one or more applications capable of providing functions for a home 1271, a dialer 1272, an SMS/MMS 1273, an instant message (IM) 1274, a browser 1275, a camera 1276, an alarm 1277, a contact 1278, a voice dial 1279, an e-mail 1280, a calendar 1281, a media player 1282, an album 1283, and a clock 1284, or for offering health care (e.g., measuring an exercise quantity or blood sugar) or environment information (e.g., information of barometric pressure, humidity, or temperature).

According to an embodiment, the application 1270 may include an application (hereinafter referred to as “information exchanging application” for descriptive convenience) to support information exchange between the electronic device (e.g., the electronic device 101) and an external electronic device (e.g., the electronic device 102 or 104). The information exchanging application may include, for example, a notification relay application for transmitting specific information to the external electronic device, or a device management application for managing the external electronic device.

For example, the information exchanging application may include a function of transmitting notification information, which arise from other applications (e.g., applications for SMS/MMS, e-mail, health care, or environmental information), to an external electronic device (e.g., the electronic device 102 or 104). Additionally, the information exchanging application may receive, for example, notification information from an external electronic device and provide the notification information to a user.

The device management application may manage (e.g., install, delete, or update), for example, at least one function (e.g., turn-on/turn-off of an external electronic device itself (or a part of components) or adjustment of brightness (or resolution) of a display) of the external electronic device (e.g., the electronic device 102 or 104) which communicates with the electronic device, an application running in the external electronic device, or a service (e.g., a call service, a message service, or the like) provided from the external electronic device.

According to an embodiment of this disclosure, the application 1270 may include an application (e.g., a health care application of a mobile medical device, and the like) which is assigned in accordance with an attribute of the external electronic device (e.g., the electronic device 102 or 104). According to an embodiment, the application 1270 may include an application which is received from an external electronic device (e.g., the server 106 or the electronic device 102 or 104). According to an embodiment, the application 1270 may include a preloaded application or a third party application which is downloadable from a server. The titles of elements in the program module 1210 according to the embodiment may be modifiable depending on kinds of operating systems.

According to various embodiments, at least a part of the program module 1210 may be implemented by software, firmware, hardware, or a combination of two or more thereof. At least a part of the program module 1210 may be implemented (e.g., executed), for example, by a processor (e.g., the processor 1110). At least a portion of the program module 1210 may include, for example, modules, programs, routines, sets of instructions, processes, or the like, for performing one or more functions.

As described above, according to an embodiment of this disclosure, an electronic device may include a display, a memory, and a processor. The processor may render a plurality of views that are based on execution of at least one application, may store the plurality of views in the memory, may generate a first image frame based on a first group of views that includes at least one view selected from the plurality of views, and may output the first image frame in the display.

According to another embodiment, the processor may output a UI, which allows a user to select the first group of views, in the display.

According to another embodiment, the first group of views may be selected by excluding, at the user, at least some of the plurality of views by using the UI.

According to another embodiment, if the first group of views includes two or more views, the processor may generate the first image frame by merging the two or more views.

According to another embodiment, the first group of views may be merged by a compositor that is implemented by the processor.

According to another embodiment, the compositor may correspond to a surface flinger.

According to another embodiment, the electronic device may further include an input/output interface operatively connected with an external electronic device. The processor may generate a second image frame based on a second group of views that includes at least one view selected from the plurality of views and may send the second image frame to the external electronic device through the input/output interface.

According to another embodiment, the electronic device may further include a communication circuit configured to establish communication with an external electronic device. The processor may generate a third image frame based on a third group of views that includes at least one view selected from the plurality of views and may send the third image frame to the external electronic device through the communication circuit.

According to another embodiment, the memory may include a plurality of buffers that store the plurality of views.

According to another embodiment, the plurality of views may be managed by a window manager that is implemented by the processor.

According to another embodiment, the plurality of views may include at least a text, an image, a video, a UI symbol, or a combination thereof.

According to an embodiment, an electronic device may include a memory configured to store information about at least one view and a processor. The processor is configured to output a first screen, which includes a first view and a second view associated with execution of at least one application, through a display operatively connected with the processor and to generate a second screen to be sent to an external electronic device based at least on selection of the first view or the second view. The second screen may include the selected view.

According to another embodiment, the first view may include content corresponding to the at least one application, and the second view may be related with the first view.

According to another embodiment, the processor may be configured to store the second screen in the memory.

According to another embodiment, the processor may be configured to select the first view or the second view based at least on a call by a system command of the electronic device.

According to another embodiment, the processor may be configured to select the first view or the second view based at least on a user input.

According to another embodiment, the processor may be configured to generate the second screen by using a view, which includes content corresponding to the at least one application, from among the first view or the second view.

According to another embodiment, the electronic device may further include a communication circuit configured to establish a communication connection with the external electronic device. The processor may be configured to send the second screen to the external electronic device by using the communication circuit.

According to another embodiment, a method of an electronic device for composing a screen may include rendering a plurality of views that are based on execution of at least one application, storing the plurality of views in a memory of the electronic device, generating a first image frame based on a first group of views that includes at least one view selected from the plurality of views, and outputting the first image frame in a display of the electronic device.

According to another embodiment, the method may further include outputting a UI for selecting the first group of views in the display.

According to another embodiment, the first group of views may be selected by excluding at least some of the plurality of views through the UI.

According to another embodiment, the generating of the first image frame may include generating the first image frame by merging two or more views if the first group of views includes the two or more views.

According to another embodiment, the method may further include generating a second image frame based on a second group of views that includes at least one view selected from the plurality of views and sending the second image frame to an external electronic device connected with the electronic device.

According to an embodiment, in a computer recording medium storing instructions that are executed by at least one processor and is readable by a computer, the instruction may cause the computer to render a plurality of views that are based on execution of at least one application, to generate a first image frame based on a first group of views that includes at least one view selected from the plurality of views, and to output the first image frame in a display of the electronic device.

According to another embodiment, the instructions may further include an instruction that causes the computer to output a UI for selecting the first group of views in the display.

According to another embodiment, the generating of the first image frame may include generating the first image frame by merging two or more views if the first group of views includes the two or more views.

According to another embodiment, the instructions may further include an instruction that causes the computer to generate a second image frame based on a second group of views including at least one view selected from the plurality of views and to send the second image frame to an external electronic device connected with the electronic device.

The term “module” used herein may represent, for example, a unit including one or more combinations of hardware, software and firmware. The term “module” may be interchangeably used with the terms “unit”, “logic”, “logical block”, “component” and “circuit”. The “module” may be a minimum unit of an integrated component or may be a part thereof. The “module” may be a minimum unit for performing one or more functions or a part thereof. The “module” may be implemented mechanically or electronically. For example, the “module” may include at least one of an application-specific IC (ASIC) chip, a field-programmable gate array (FPGA), and a programmable-logic device for performing some operations, which are known or will be developed.

At least a part of an apparatus (e.g., modules or functions thereof) or a method (e.g., operations) according to various embodiments of this disclosure may be, for example, implemented by instructions stored in a computer-readable storage media in the form of a program module. The instruction, when executed by a processor (e.g., the processor 170), may cause the one or more processors to perform a function corresponding to the instruction. The computer-readable storage media, for example, may be the memory 130.

A computer-readable recording medium may include a hard disk, a magnetic media, a floppy disk, a magnetic media (e.g., a magnetic tape), an optical media (e.g., a compact disc read only memory (CD-ROM) and a digital versatile disc (DVD), a magneto-optical media (e.g., a floptical disk), and hardware devices (e.g., a read only memory (ROM), a random access memory (RAM), or a flash memory). Also, a program instruction may include not only a mechanical code such as things generated by a compiler but also a high-level language code executable on a computer using an interpreter. The above hardware unit may be configured to operate as one or more software modules to perform an operation according to various embodiments, and vice versa.

A module or a program module according to various embodiments of this disclosure may include at least one of the above elements, or a part of the above elements may be omitted, or additional other elements may be further included. Operations performed by a module, a program module, or other elements according to various embodiments of this disclosure may be executed sequentially, in parallel, repeatedly, or in a heuristic method. In addition, a part of operations may be executed in different sequences or may be omitted. Alternatively, other operations may be added.

According to an embodiment of this disclosure, a user may reconfigure an execution screen of an application displayed in an electronic device at his/her own preference. For example, when a view that he/she does not desire is included in the execution screen (or an image frame) of the application, the user may remove the view depending on his/her determination.

In addition, according to an embodiment, the user may reconfigure an execution screen of an external electronic device, which shares the execution screen of the application, as well as the execution screen of the application displayed in his/her electronic device at his/her own preference. This may mean that the user is capable of removing a view including an unnecessary content or content that he/she does not desire to share.

In addition, according to an embodiment, if a developer of the application considers that the execution screen of the application is output in a plurality of electronic devices, there is no need to configure each of activity screens in advance such that each of the activity screens is suitable for the plurality of electronic devices. Furthermore, according to an embodiment, the electronic device may generate an image frame to be provided to the external electronic device by using a view that is rendered for the image frame to be provided to an embedded display. Accordingly, the electronic device may not repeatedly render the view of the image frame to be provided to the external electronic device from the beginning, again. Accordingly, a power resource and a computing resource that are unnecessary may be restrained from being used.

Besides, a variety of effects directly or indirectly understood through this disclosure may be provided.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. An electronic device comprising:
a display;
a memory; and
a processor, wherein the processor is configured to:
render a plurality of views that are based on execution of at least one application;
store the plurality of views in the memory;
generate a first image frame based on a first group of views that comprises at least one view selected from the plurality of views; and
output the first image frame in the display.

2. The electronic device of claim 1, wherein the processor is further configured to output a user interface (UI) on the display, wherein the UI allows a user to select the first group of views.

3. The electronic device of claim 2, wherein the first group of views is selected by excluding, based on an input from the user through the UI, at least some of the plurality of views.

4. The electronic device of claim 1, wherein if the first group of views comprises two or more views, and wherein the processor is configured to generate the first image frame by merging the two or more views.

5. The electronic device of claim 4, wherein the processor is configured to implement a compositor to merge the first group of views.

6. The electronic device of claim 5, wherein the compositor corresponds to a surface flinger.

7. The electronic device of claim 1, further comprising:
an input/output interface operatively connected with an external electronic device, and wherein the processor is further configured to:
generate a second image frame based on a second group of views that comprises at least one view selected from the plurality of views; and
send the second image frame to the external electronic device through the input/output interface.

8. The electronic device of claim 1, further comprising:
a communication circuit configured to establish communication with an external electronic device,
wherein the processor is further configured to:
generate a third image frame based on a third group of views that comprises at least one view selected from the plurality of views; and
send the third image frame to the external electronic device through the communication circuit.

9. The electronic device of claim 1, wherein the memory comprises a plurality of buffers that store the plurality of views.

10. The electronic device of claim 1, wherein the processor is configured to implement a window manager to manage the plurality of views.

11. The electronic device of claim 1, wherein the plurality of views comprise at least one of a text, an image, a video, a UI symbol, or a combination thereof.

12. A method of an electronic device for composing a screen, the method comprising:
rendering a plurality of views that are based on execution of at least one application;
storing the plurality of views in a memory of the electronic device;
generating a first image frame based on a first group of views that comprises at least one view selected from the plurality of views; and
outputting the first image frame in a display of the electronic device.

13. The method of claim 12, further comprising:
outputting a UI for selecting the first group of views on the display.

14. The method of claim 13, further comprising:
excluding at least some of the plurality of views through the UI to select the first group of views.

15. The method of claim 12, wherein the generating of the first image frame comprises generating the first image frame by merging two or more views if the first group of views comprises the two or more views.

16. The method of claim 12, further comprising:
generating a second image frame based on a second group of views that comprises at least one view selected from the plurality of views; and
sending the second image frame to an external electronic device connected with the electronic device.

17. An electronic device comprising:
a memory configured to store information about at least one view; and
a processor, wherein the processor is configured to:
output a first screen through a display operatively connected with the processor, wherein the first screen comprises a first view and a second view associated with execution of at least one application,; and
generate a second screen, to be sent to an external electronic device, based at least on selection of the first view or the second view, wherein the second screen comprises the selected view.

18. The electronic device of claim 17,
wherein the first view comprises content corresponding to the at least one application, and
wherein the second view is related to the first view.

19. The electronic device of claim 17, wherein the processor is configured to generate the second screen by using a view, which comprises content corresponding to the at least one application, from among the first view or the second view.

20. The electronic device of claim 17, further comprising:
a communication circuit configured to establish a communication connection with the external electronic device,
wherein the processor is configured to send the second screen to the external electronic device by using the communication circuit.
